(19) United States
(12) Patent Application Publication
(10) Pub. No.: US 2005/0053222 A1
(43) Pub. Date: Mar. 10, 2005

(54) Incoming and outgoing call system based on duplicate private network

(75) Inventors: Jeong-mi Lee, Gyeonggi-do (KR); Jin-seok Kim, Gyeonggi-do (KR); Chang Whie, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/714,397

(22) Filed: Nov. 17, 2003

(30) Foreign Application Priority Data
Nov. 16, 2002 (KR) 2002-71394

(51) Int. Cl. H04M 7/00; H04L 12/66

(52) U.S. Cl. 379/219; 370/352

(57) ABSTRACT

A calling system based on a private network includes an outgoing call transmission unit, an outgoing call setting unit, and an incoming call reception unit. The outgoing call transmission unit receives a calling number, creates an outgoing call, and transmits the outgoing call to a gateway having a first IP address, which is the address of a relay of the private network, if a second IP address, which is the address of an exit of the private network, is allotted to a calling terminal. The outgoing call setting unit transmits a request for setting an outgoing call to the gateway, if the outgoing call transmission unit transmits the outgoing call to the gateway. The incoming call reception unit receives an incoming call from the gateway if the second IP address allotted to the calling terminal is an incoming internal private IP address, translated from an incoming internal public IP address.

### BACKGROUND OF THE INVENTION

This application claims the priority of Korean Patent Application No. 10-2002-0071394, filed on Nov. 16, 2002, in the Korean Intellectual Property Office, the disclosure of which is incorporated herein in its entirety by reference.

1. Field of the Invention

The present invention relates to a private network-based incoming and outgoing call system capable of enabling incoming and outgoing calls based on a private network.

2. Description of the Related Art

There are two conventional techniques of enabling incoming and outgoing call systems to communicate with each other, i.e., a circuit switching technique and a packet switching technique. The circuit switching technique indicates a data transmission manner in which a single telephone circuit is exclusively occupied by one person to receive voice and fax data from or transmit voice and fax data to another person. However, the fact that one person exclusively occupies a single telephone circuit restricts types of telephone communications that the circuit switching technique can provide to one-on-one type telephone communications rather than allowing it to provide telephone communications among a plurality of people.

On the other hand, the packet switching technique indicates a data transmission manner in which data is segmented into packets and the packets are transmitted to circuits that constitute a network, such as the Internet. In the packet switching technique, unlike in the circuit switching technique, different types of packets may be transmitted together. Therefore, a telephone circuit is shared by a plurality of users rather than one user. In order for a plurality of users to receive data packets from or transmit data packets to one another, an Internet protocol (IP) address should be allotted to each node of the Internet network. Here, the IP address allotted to each node of the Internet network could be a public IP address or a private IP address. In the case of allotting a public IP address to a node of the Internet network, the problem of a shortfall of IP addresses may arise because a public IP address is required to be in a range between 0.0.0.0 and 255.255.255.255. Since the number of possible public IP addresses is restricted, it is impossible to allot different IP public addresses to different incoming and outgoing call systems if the number of incoming and outgoing call systems surpasses the number of possible public IP addresses. In addition, public IP addresses are relatively expensive to use. Due to the fixed number of public IP addresses, public IP addresses are dynamically allotted to nodes of the Internet network. In this case, each incoming and outgoing call system can make calls. However, since each incoming and outgoing call system does not have any fixed IP address, it cannot receive calls.

On the other hand, private IP addresses can be allotted to nodes of the Internet either dynamically or statically. When dynamically allotting private IP addresses to incoming and outgoing call systems, the incoming and outgoing call systems can make calls. In this case, like in the case of dynamically allotting public IP addresses to the incoming and outgoing call systems, the incoming and outgoing call systems cannot receive calls. In the case of statically allotting private IP addresses to the incoming and outgoing call systems, the incoming and outgoing call systems can make and receive calls. Let us assume that a plurality of incoming and outgoing call systems are provided in a certain place. In this case, a single private IP address is allotted to all of the plurality of incoming and outgoing call systems. Accordingly, the incoming and outgoing call systems operate like a single incoming and outgoing call system rather than like separate ones, for example, telephones with different phone numbers.

### SUMMARY OF THE INVENTION

The present invention provides an apparatus and a method that enable a plurality of people to talk to one another over the phone at the same time by allowing a plurality of voice-over-IP (VoIP)-type incoming and outgoing call systems to operate, based on a duplicate private network, separately from one another like different telephones with different phone numbers.

According to an exemplary aspect of the present invention, there is provided an incoming and outgoing call terminal on a duplicate private network, including an outgoing call transmission unit, an outgoing call setting requesting message transmission unit, and an incoming call reception unit. The outgoing call transmission unit receives a calling number, creates an outgoing call including information of the received calling number, and transmits the outgoing call to a gateway having a first private internet protocol (IP) address, which is the address of a relay of the duplicate private network, if a second private IP address, which is the address of an exit of the duplicate private network, is allotted to the incoming and outgoing call terminal. The outgoing call setting requesting message transmission unit creates a message requesting the setting of an outgoing call and transmits the message to the gateway if the outgoing call transmission unit transmits the outgoing call to the gateway. The incoming call reception unit receives an incoming call from the gateway if the second private IP address allotted to the incoming and outgoing call terminal is an incoming internal private IP address, into which an incoming internal public IP address is translated by a network address translator (NAT) server, wherein the incoming internal public IP address is destination information corresponding to called number information included in the incoming call and the address of an entrance of the duplicate private network.

According to another exemplary aspect of the present invention, there is provided a gateway on a duplicate private network, including an outgoing call setting requesting message transmission unit, an outgoing call transmission unit, an incoming call multi-transmission unit, and an incoming call uni-transmission unit. The outgoing call setting requesting message transmission unit receives a message requesting the setting of an outgoing call from an incoming and outgoing call terminal, to which a second private IP address, which is the address of an exit of the duplicate private network, is allotted, and transmits the message to a gatekeeper having an outgoing internal public IP address, which is translated by an NAT server from the second private IP address and is source information corresponding to calling number information included in an outgoing call and the address of an entrance of the duplicate private network, if a first private IP address, which is the address of a relay of the duplicate private network, is allotted to the gateway. The outgoing call transmission unit transmits the outgoing call to the gatekeeper in response to the reception of the outgoing call from the incoming and outgoing call terminal if the outgoing call setting requesting message transmission unit transmits the message requesting the setting of an outgoing call to the gatekeeper. The incoming call multi-transmission unit receives an incoming call from the gatekeeper and transmits the received incoming call to all incoming and outgoing call terminals connected to the duplicated private network gateway if the first private IP address allotted to the duplicated private network gateway is an incoming internal private IP address, translated from an incoming internal public IP address, which is destination information corresponding to called number information included in the incoming call. The incoming call uni-transmission unit receives an incoming call from the gatekeeper and transmits the received incoming call to an incoming and outgoing call terminal having the incoming internal private IP address and directly connected to the gateway if the first private IP address allotted to the gateway is not the incoming internal private IP address.

According to another exemplary aspect of the present invention, there is provided a gatekeeper on a duplicate private network, including an outgoing call setting requesting message receiver, an outgoing call setting unit, an outgoing call transmission unit, and an incoming call transmission unit. The outgoing call setting requesting message receiver receives a message requesting the setting of an outgoing call from a gateway having the address of a relay of the duplicate private network. The outgoing call setting unit sets a communication path connecting the gateway and an external incoming node in an external network, having an incoming external public IP address, which is translated by an NAT server from a private IP address of an incoming and outgoing call terminal that has transmitted the message requesting the setting of an outgoing call and is destination information corresponding to called number information included in an outgoing call and the address of an entrance of a duplicate private network, when the outgoing call setting requesting message reception unit receives the message requesting the setting of an outgoing call. The outgoing call transmission unit receives the outgoing call from the gateway and transmits the received outgoing call to the external incoming node along the communication path for the outgoing call. The incoming call transmission unit receives an incoming call and transmits the received incoming call to a gateway having the address of a relay of the duplicate private network, such as a private IP address translated from the incoming internal public IP address by the NAT server, if the gatekeeper has an incoming internal public IP address, which is destination information corresponding to called number information included in the incoming call that has been transmitted along a communication path by an external outgoing call node through incoming call setting, and is the address of an entrance of a duplicate private network.

According to another exemplary aspect of the present invention, there is provided a duplicate private network management server, including a private IP address information storing unit, a private IP address allocation requesting message reception unit, a private IP address allocation message transmitter, and a private IP address deletion requesting message reception unit. The private IP address information storing unit creates private IP address information, including a database of allotted private IP addresses and private IP addresses yet to be allotted, or receives the private IP address information from a gateway having the address of a relay of a duplicate private network and stores the received private IP address information. The private IP address allocation requesting message reception unit receives a message requesting private IP address allocation, including information on which incoming and outgoing call terminals to which private IP addresses are not allotted, from the gateway. The private IP address allocation message transmitter creates a private IP address allocation message based on the private IP address information in response to the reception of the message requesting private IP address allocation and transmits the private IP address allocation message to a dynamic host configuration protocol (DHCP) server. The private IP address deletion requesting message reception unit receives a message requesting private IP address deletion, including information on private IP addresses that are no longer in use, from the gateway. The private IP address deletion message transmitter creates a private IP address deletion message based on the private IP address information in response to the reception of the message requesting private IP address deletion and transmits the private IP address deletion message to the DHCP server. The private IP address information updating unit updates the private IP address information in response to the private IP address allocation message or the private IP address deletion message.

According to another exemplary aspect of the present invention, there is provided an incoming and outgoing call system based on a duplicate private network, including an incoming and outgoing call terminal, a gateway, and a gatekeeper. If a second private IP address, which is the address of an exit of the duplicate private network, is allotted, the incoming and outgoing call terminal receives a calling number, creates an outgoing call including information of the received calling number, and transmits the outgoing call to a gateway having a first private IP address, which is the address of a relay of the duplicate private network. The incoming and outgoing call terminal creates a message requesting the setting of an outgoing call and transmits the message to the gateway. If the second private IP address allotted thereto is an incoming internal private IP address, which is translated by an NAT server, from an incoming internal public IP address that is destination information corresponding to called number information included in the incoming call and the address of an entrance of the duplicate private network, the incoming and outgoing call terminal receives an incoming call from the gateway. If the first private IP address is allotted, the gateway receives the message requesting the setting of an outgoing call from the incoming and outgoing call terminal, to which the second private IP address is allotted, and transmits the message to a gatekeeper having an outgoing internal public IP address, which is translated by an NAT server from the second private IP address and is source information corresponding to calling number information included in an outgoing call and the address of an entrance of the duplicate private network. If the outgoing call has been transmitted from the incoming and outgoing call terminal to which the second private IP address is allotted, the gateway transmits the outgoing call to the gatekeeper in response to the reception of the outgoing call from the incoming and outgoing call terminal. If the first private IP address allotted thereto is the incoming internal private IP address, the gateway transmits the received incoming call to all incoming and outgoing call terminals connected thereto. If the first private IP address allotted thereto is not the incoming internal private IP address, the gateway transmits the received incoming call to an incoming and outgoing call terminal having the incoming internal private IP address and directly connected to the gateway. The gatekeeper receives the message requesting the setting of an outgoing call from the gateway. The gatekeeper sets a communication path connecting the gateway and an external incoming node in an external network, having an incoming external public IP address that is destination information corresponding to called number information included in the outgoing call. In addition, the gatekeeper receives the outgoing call from the gateway and transmits the received outgoing call to the external incoming node along the communication path for the outgoing call. If an incoming internal public IP address, which is destination information corresponding to called number information included in the incoming call that has been transmitted along a communication path by an external outgoing call node through incoming call setting, and is the address of an entrance of the duplicate private network, the gatekeeper receives the incoming call and transmits the received incoming call to a gateway having the address of a relay of the duplicate private network, such as a private IP address translated from the incoming internal public IP address by the NAT server.

According to another exemplary aspect of the present invention, there is provided a method of enabling an outgoing call and receiving an incoming call in an incoming and outgoing call terminal on a duplicate private network, which involves (a) receiving a calling number, creating an outgoing call including information of the received calling number, and transmitting the outgoing call to a gateway having a first private IP address, which is the address of a relay of the duplicate private network, if a second private IP address, which is the address of an exit of the duplicate private network, is allotted to the incoming and outgoing call terminal; (b) creating a message requesting the setting of an outgoing call and transmitting the message to the gateway if the outgoing call is transmitted to the gateway; and (c) receiving an incoming call from the gateway if the second private IP address allotted to the incoming and outgoing call terminal is an incoming internal private IP address, into which an incoming internal public IP address is translated by an NAT server, wherein the incoming internal public IP address is destination information corresponding to called number information included in the incoming call and the address of an entrance of the duplicate private network.

According to another exemplary aspect of the present invention, there is provided a method of enabling an outgoing call and receiving an incoming call in an incoming and outgoing call terminal on a duplicate private network, which involves (e) creating a message requesting private IP address allocation, including information of incoming and outgoing call terminals to which private IP addresses are not allotted, and transmitting the message to a duplicate private network management server unless the first private IP address is allotted to the gateway; (f) a DHCP server allotting private IP addresses to the gateway in response to the reception of the message; (g) allotting the first private IP address, among the allotted private IP addresses, to the gateway; and (h) allotting the second private IP address, among the allotted private IP addresses, to the incoming and outgoing call terminal directly connected to the gateway.

According to another exemplary aspect of the present invention, there is provided a method of enabling an outgoing call and receiving an incoming call in a gatekeeper on a duplicate private network, which involves (a) receiving a message requesting the setting of an outgoing call from a gateway having the address of a relay of the duplicate private network; (b) setting a communication path connecting the gateway and an external incoming node in an external network, having an incoming external public IP address, which is translated by an NAT server from a private IP address of an incoming and outgoing call terminal that has transmitted the message requesting the setting of an outgoing call and is destination information corresponding to called number information included in an outgoing call and the address of an entrance of a duplicate private network, when the outgoing call setting requesting message reception unit receives the message requesting the setting of an outgoing call; (c) receiving the outgoing call from the gateway and transmitting the received outgoing call to the external incoming node along the communication path for the outgoing call; and (d) receiving an incoming call and transmitting the received incoming call to a gateway having the address of a relay of the duplicate private network, such as a private IP address translated from the incoming internal public IP address by the NAT server, if the gatekeeper has an incoming internal public IP address, which is destination information corresponding to called number information included in the incoming call that has been transmitted along a communication path by an external outgoing call node through incoming call setting, and is the address of an entrance of a duplicate private network.

According to another exemplary aspect of the present invention, there is provided a method of enabling an outgoing call and an incoming call in a duplicate private network management server, which involves (a) creating private IP address information, including a database of allotted private IP addresses and private IP addresses yet to be allotted, or receiving the private IP address information from a gateway having the address of a relay of the duplicate private network and storing the received private IP address information; (b) receiving a message requesting private IP address allocation, including information on which incoming and outgoing call terminals to which private IP addresses are not allotted, from the gateway; (c) creating a private IP address allocation message based on the private IP address information in response to the reception of the message requesting private IP address allocation and transmitting the private IP address allocation message to a DHCP server; (d) receiving a message requesting private IP address deletion, including information on private IP addresses that are no longer in use, from the gateway; (e) creating a private IP address deletion message based on the private IP address information in response to the reception of the message requesting private IP address deletion and transmitting the private IP address deletion message to the DHCP server; and (f) updating the private IP address information in response to the private IP address allocation message or the private IP address deletion message.

According to another exemplary aspect of the present invention, there is provided a method of enabling an outgoing call and an incoming call in an incoming and outgoing call system based on a duplicate private network, which comprises an incoming and outgoing call terminal, a gateway, and a gatekeeper. The method involves (a) if a second private IP address, which is the address of an exit of the duplicate private network, is allotted to the incoming and outgoing call terminal, receiving a calling number, creating an outgoing call including information of the received calling number, and transmitting the outgoing call to a gateway having a first private IP address, which is the address of a relay of the duplicate private network; creating a message requesting the setting of an outgoing call and transmits the message to the gateway; and if the second private IP address allotted to the incoming and outgoing call terminal is an incoming internal private IP address, which is translated by an NAT server from an incoming internal public IP address that is destination information corresponding to called number information included in the incoming call and the address of an entrance of the duplicate private network, receiving an incoming call from the gateway; (b) if the first private IP address is allotted to the gateway, receiving the message requesting the setting of an outgoing call from the incoming and outgoing call terminal, to which the second private IP address is allotted, and transmitting the message to a gatekeeper having an outgoing internal public IP address, which is translated by an NAT server from the second private IP address and is source information corresponding to calling number information included in an outgoing call and the address of an entrance of the duplicate private network; if the outgoing call has been transmitted from the incoming and outgoing call to which the second private IP address is allotted, transmitting the outgoing call to the gatekeeper in response to the reception of the outgoing call from the incoming and outgoing call terminal; if the first private IP address allotted thereto is the incoming internal private IP address, transmitting the received incoming call to all incoming and outgoing call terminals connected thereto; and if the first private IP address allotted thereto is not the incoming internal private IP address, transmitting the received incoming call to an incoming and outgoing call having the incoming internal private IP address and directly connected to the gateway; and (c) receiving the message requesting the setting of an outgoing call from the gateway; setting a communication path connecting the gateway and an external incoming node in an external network, having an incoming external public IP address that is destination information corresponding to called number information included in the outgoing call; receiving the outgoing call from the gateway and transmitting the received outgoing call to the external incoming node along the communication path set for the outgoing call; and, if an incoming internal public IP address is to the gatekeeper, receiving the incoming call and transmitting the received incoming call to a gateway having the address of a relay of the duplicate private network, such as a private IP address translated from the incoming internal public IP address by the NAT server, wherein the incoming internal public IP address is destination information corresponding to called number information included in the incoming call that has been transmitted along a communication path set by an external outgoing call node through incoming call setting, and is the address of an entrance of the duplicate private network.

### BRIEF DESCRIPTION OF THE DRAWINGS

The above and other exemplary features and advantages of the present invention will become more apparent by describing in detail illustrative, non-limiting embodiments thereof with reference to the attached drawings in which:

FIG. 1 is a block diagram of an incoming and outgoing call system based on a duplicate private network according to an illustrative embodiment of the present invention;

FIG. 2 is a block diagram of an incoming and outgoing call terminal based on a duplicate private network according to an illustrative embodiment of the present invention;

FIG. 3 is a diagram illustrating a gateway according to an illustrative embodiment of the present invention;

FIG. 4 is a diagram illustrating a gatekeeper according to an illustrative embodiment of the present invention;

FIG. 5 is a block diagram of a duplicate private network management server according to an illustrative embodiment of the present invention;

FIG. 6 is a flowchart illustrating a method of creating an outgoing call using an incoming and outgoing call system based on a duplicate private network according to an illustrative embodiment of the present invention;

FIG. 7 is a flowchart illustrating a method of receiving an incoming call using an incoming and outgoing call system based on a duplicate private network according to an illustrative embodiment of the present invention;

FIG. 8 is a flowchart illustrating a method of making and receiving an incoming call using an incoming and outgoing call terminal based on a duplicate private network according to an illustrative embodiment of the present invention;

FIG. 9 is a flowchart illustrating a method of creating an outgoing call and receiving an incoming call in a gateway according to an illustrative embodiment of the present invention;

FIG. 10 is a flowchart illustrating the method of FIG. 9 in a case where a message requesting a private IP address is received (92);

FIG. 11 is a flowchart illustrating the method of FIG. 9 in a case where a first private IP address allotted to a gateway is no longer in use (93); `

FIG. 12 is a flowchart illustrating the method of FIG. 9 in a case where a message requesting private IP address deletion is received (94);

FIG. 13 is a flowchart illustrating a method of creating an outgoing call and receiving an incoming call in a gatekeeper according to an illustrative embodiment of the present invention; and

FIG. 14 is a flowchart illustrating a method of creating an outgoing call and receiving an incoming call in a duplicate private network management server according to an illustrative embodiment of the present invention.

### DETAILED DESCRIPTION OF THE INVENTION

Hereinafter, the present invention will now be described more fully with reference to the accompanying drawings in which illustrative, non-limiting embodiments of the invention are shown. In the following paragraphs, ‘calls’ indicate voice over Internet protocol (VoIP)-type calls. VoIP is a term representing an IP telephone technique adopted by a variety of equipments that transmit voice data using IP. In general, VoIP indicates that voice data is transmitted in a digital manner, carried by discontinuous packets without the need of conventional protocols based on telephone circuits, such as public switched telephone network (PSTN).

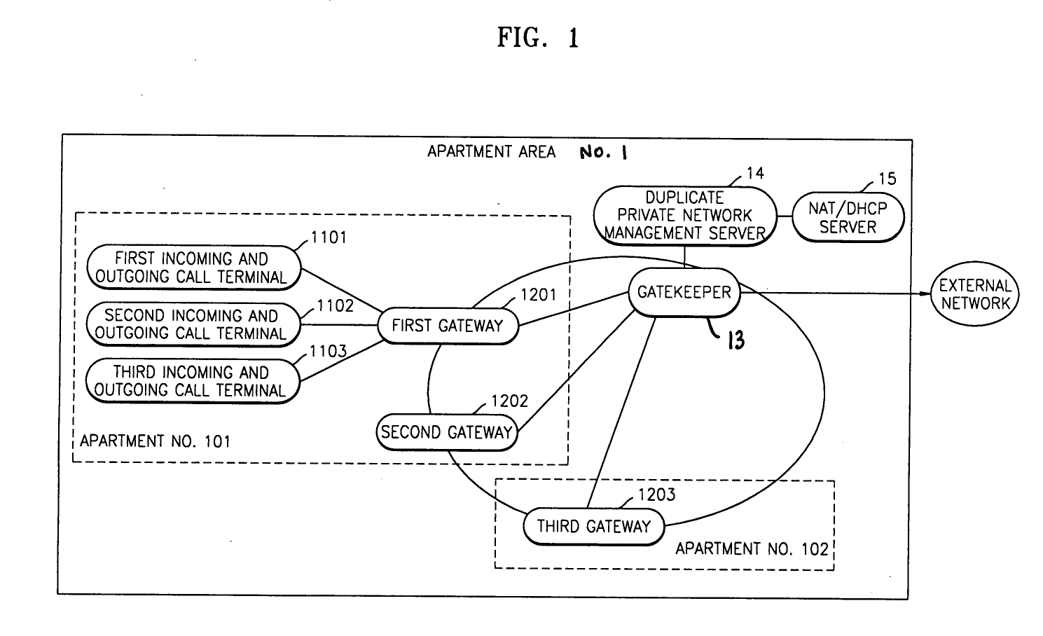

FIG. 1 is a diagram illustrating the structure of an incoming and outgoing call system based on a duplicate private network according to an illustrative embodiment of the present invention. The duplicate private network-based incoming and outgoing call system includes incoming and outgoing call terminals 1101, 1102, and 1103, gateways 1201, 1202, and 1203, a gatekeeper 13, a duplicate private network management server 14, a dynamic host configuration protocol (DHCP) server 15, and a network address translator (NAT) server 15. The DHCP server 15 and the NAT server 15 may be integrated into a single server, as shown in FIG. 1, or may be separate.

A duplicate private network is a local area network (LAN) constituted by incoming and outgoing call terminals, gateways, and a gatekeeper. In particular, a LAN constituted by a gatekeeper and a plurality of gateways is called a primary LAN, and a LAN constituted by a gateway and a plurality of incoming and outgoing call terminals is called a secondary LAN. The duplicate private network is constituted by a primary LAN and a plurality of secondary LANs connected to the primary LAN. From an external network's viewpoint, a gatekeeper may be identified as an entrance of the duplicate private network, each gateway as a relay node, and each incoming and outgoing call terminal as an exit of the duplicate private network. Here, the terms ‘entrance’, ‘relay node’, and ‘exit’ are simply used to clarify the concepts of a gatekeeper, a gateway, and an incoming and outgoing terminal and thus have nothing to do with enabling incoming and outgoing calls.

In the case of creating an outgoing call, the incoming and outgoing call terminals 1101, 1102, and 1103 receive a calling number. In a case where second private IP addresses are allotted to the incoming and outgoing call terminals 1101, 1102, and 1103, the incoming and outgoing call terminals 1101, 1102, and 1103 create an outgoing call containing information on the received calling number and transmit the outgoing call to a gateway. Here, the second private IP addresses are the addresses of exits of a duplicate private network. In the case of receiving an incoming call, the incoming and outgoing call terminals 1101, 1102, and 1103 create a message requesting the setting of an outgoing call and transmit the message to the gateway. In a case where second private IP addresses are allotted to the incoming and outgoing call terminals 1101, 1102, and 1103 and an incoming internal private IP address is also a second private IP address, the incoming and outgoing call terminals 1101, 1102, and 1103 receive the incoming call from the gateway. Here, the incoming internal private IP address is a translated version of an incoming call public IP address. The incoming call public IP address is destination information corresponding to called number information and is also the address of an entrance of the duplicate private network.

Let us assume that first private IP addresses are allotted to the gateways 1201, 1202, and 1203. Then, in the case of creating an outgoing call, the gateways 1201, 1202, and 1203 receive a message requesting the setting of an outgoing call from an incoming and outgoing call terminal to which a second private IP address is allotted and transmit the message to a gatekeeper to which an outgoing internal public IP address is allotted. The outgoing internal public IP address is a translated version of a second private IP address. The second private IP address is source information corresponding to calling number information included in an outgoing call and is also the address of an entrance of the duplicate private network. In a case where the gateways 1201, 1202, and 1203 receive an incoming call from an incoming and outgoing call terminal to which a second private IP address is allotted, they transmit an outgoing call to a gatekeeper to which an internal public IP address is allotted. In the case of receiving an incoming call, the gateways 1201, 1202, and 1203 receive an incoming call from a gatekeeper to which a first private IP address is allotted. If the first private IP address is an incoming internal private IP address, the gateways 1201, 1202, and 1203 transmit the incoming call to all incoming and outgoing call terminals connected thereto. Otherwise, the gateways 1201, 1202, and 1203 transmit the incoming call to incoming and outgoing call terminals having an incoming internal private IP address.

In a process of creating an outgoing call, the gatekeeper 13 receives a message requesting the setting of an outgoing call from a gateway. If the gatekeeper 13 has an outgoing internal public IP address, it sets a communication circuit having an incoming external public IP address and connected to an external incoming node belonging to an external network. The incoming external public IP address is destination information corresponding to called number information contained in an outgoing call. Thereafter, the gatekeeper 13 receives an outgoing call from the gateway and transmits the received call to the external outgoing call node along a communication path passing through the communication circuit set by incoming call setting. In a case where the gatekeeper 13 has an incoming internal public IP address, it receives an incoming call and transmits the received call to a gateway having a relay address of a duplicate private network having private IP addresses that are translated from incoming internal public IP addresses. Here, the incoming internal public IP address is the address of an entrance of the duplicate private network and is also destination information included in called number information, and the called number information is contained in an incoming call that has been transmitted along a communication path set by an external outgoing call node's incoming call setting. The gatekeeper 13 serves as a server that associates a called number with an incoming internal public IP address, working together with another gateway existing in an external network.

Unless first private IP addresses are allotted to the gateways 1201, 1202, and 1203, they create and transmit a message requesting private IP address allocation. Here, the message includes information of incoming and outgoing call terminals, connected to the gateways 1201, 1202, and 1203, to which private IP addresses are not allotted. In response to the reception of the message, private IP addresses are allotted to the gateways 1201, 1202, and 1203. Then, each of the gateways 1201, 1202, and 1203 takes a first one, i.e., a first private IP addresses, among the private IP addresses allotted thereto as its IP address and then allots the remainder, i.e., second private IP addresses, to the incoming and outgoing call terminals, connected thereto, to which private IP addresses are not allotted. If first private IP addresses are allotted to the gateways 1201, 1202, and 1203 but are no longer in use, the gateways 1201, 1202, and 1203 create and transmit a message requesting the deletion of the first private IP addresses that are no longer in use. Here, the message includes information of the private IP addresses. Accordingly, all the private IP addresses allotted to the gateways 1201, 1202, and 1203 are deleted.

The duplicate private network management server 14 may create private IP address information by itself. Alternatively, the duplicate private network management server 14 may receive private IP address information from gateways and store the private IP address information. The duplicate private network management server 14 receives a message requesting private IP address allocation from a gateway and creates and transmits a private IP address allocation message based on the private IP address information. In response to the private IP address allocation message and a private IP address deletion message, the duplicate private network management server 14 updates the private IP address information.

The private IP address information is a database of private IP addresses allotted to incoming and outgoing call terminals and private IP addresses yet to be allotted and is stored in non-volatile memory in the duplicate private network management server 14. The private IP address information may be stored in a default form as information provided by a VoIP service provider when installing a duplicate private network-based incoming and outgoing call system according to the present invention in an apartment building. Then, if the private IP address information changes due to additional installations or withdrawals of incoming and outgoing call terminals, changes made to the private IP address information are transmitted from gateways in real-time and then reflected in the private IP address database. This process enables more efficient and flexible management of private IP addresses by reflecting installations or withdrawals of incoming and outgoing call terminals in a private IP address database.

When a message requesting private IP address allocation is received, the DHCP server 15 generates private IP addresses and allots them to gateways. When a private IP address deletion message is received, the DHCP server 15 deletes private IP addresses that are no longer in use from gateways. In short, the DHCP server 15 manages IP addresses and allots them to gateways. In addition, when incoming and outgoing call terminals change their node connections in a network, the DHCP server 15 automatically allots new IP addresses to the incoming and outgoing call terminals. The DHCP server 15 actually lends IP addresses to incoming and outgoing call terminals so that the IP addresses are valid only for a predetermined amount of time. Lending time, i.e., the predetermined amount of time during which the IP addresses allotted to the incoming and outgoing call terminals are valid, may vary depending on where and how long a user needs to be connected to the DHCP server 15. The DHCP server 15 can dynamically restructure a network by shortening IP address lending time even when the number of incoming and outgoing call terminals surpasses the number of IP addresses yet to be allotted. However, the DHCP server 15 can provide a static IP address to a server that needs a permanent IP address.

When a message requesting the setting of an outgoing call is received, the NAT server 15 translates a private IP address of an incoming and outgoing call terminal that has transmitted the message to the NAT server 15 into an outgoing internal public IP address. When an incoming call is received, the NAT server 15 translates an incoming internal public IP address into a private IP address. The NAT server 15 translates a private IP address into a public IP address, and vice versa. Accordingly, it is possible to access the Internet at a node to which a private IP address that cannot be recognized by an external network is allotted. Private IP addresses need to one-to-one-correspond to public IP addresses. However, it is possible to make a node having a public IP address communicate with a plurality of nodes having private IP addresses by identifying communication port serial numbers of transmission control protocol (TCP)/user datagram protocol (UDP) and managing correspondence between private IP addresses and public IP addresses based on identification results.

As described above, a duplicate private network is a private network comprised of incoming and outgoing call terminals, gateways, and gatekeepers. A primary private network is comprised of a gatekeeper and a plurality of gateways, and a secondary private network is comprised of a gateway and a plurality of incoming and outgoing call terminals. In order to enable incoming and outgoing calls by dynamically using IP addresses, the DHCP server 15 allots the IP addresses to a gatekeeper, gateways, and incoming and outgoing call terminals in the following manner. The DHCP server 15 allots a public IP address, which is a static IP address that can be recognized by an external network, to a gatekeeper. Thereafter, the DHCP server 15 allots a plurality of private IP addresses to gateways and then allots another plurality of private IP addresses to incoming and outgoing call terminals. The private IP addresses allotted to the gateways are called first private IP addresses, and the private IP addresses allotted to the incoming and outgoing call terminals are called second private IP addresses. The first and second private IP addresses can be dynamically allotted to the gateways and the incoming and outgoing call terminals. Let us assume that there is no plan to additionally install or withdraw incoming and outgoing call terminals. In this case, once private IP addresses are allotted to incoming and outgoing call terminals, they are considered static rather than dynamic so that the incoming and outgoing call terminals given the private IP addresses operate separately as if they were like different telephones with different phone numbers.

An incoming call that has been transmitted from an external network in a data packet form arrives at an incoming and outgoing call terminal via a gatekeeper and a gateway. In the data packet header of the incoming call, source and destination addresses are recorded. Since the incoming call needs to be transmitted through the Internet, the source and destination addresses should be public IP addresses. The gatekeeper calls the public IP address corresponding to the destination address an incoming internal public IP address. The destination address corresponds to called number information included in the incoming call. The NAT server 15 calls a private IP address an incoming internal private IP address. Here, the private IP address is a translated version of the incoming internal public IP address. The incoming call is transmitted to an incoming and outgoing call terminal having the incoming internal private IP address.

Let us assume that three incoming and outgoing call terminals are installed in apartment building No. 101 in apartment building area No. 1, as shown in FIG. 1. In the corresponding apartment building area, the gatekeeper 13, the duplicate private network management server 14, the NAT/DHCP server 15, the gateways 1201, 1202, and 1203, and the incoming and outgoing call terminals 1101, 1102, and 1103 are installed.

The gatekeeper 13 works together with an external gatekeeper at an arbitrary node in an external network to translate telephone numbers into IP addresses and sets VoIP calls. The duplicate private network management server 14 communicates with the gateways 1201, 1202, and 1203 and provides a variety of additional services, such as storing of private IP address information. The NAT/DHCP server 15 allots dynamic or static private IP addresses to the gateways 1201, 1202, and 1203. The gateways 1201, 1202, and 1203, which are devices interfacing a LAN and a wide area network (WAN), allot private IP addresses to the incoming and outgoing call terminals 1101, 1102, and 1103. The incoming and outgoing call terminals 1101, 1102, and 1103 are user terminals that execute a variety of application programs and enable users to make and receive VoIP calls. In order to enable such service, servers share a database of private IP addresses allotted to gateways, and the NAT/DHCP server 15, in particular, allots to the gateways 1201, 1202, and 1203 and incoming and outgoing call terminals 1101, 1102, and 1103 connected to the gateways 1201, 1202, and 1203 as many private IP addresses as there are gateways 1201, 1202, and 1203 and incoming and outgoing call terminals 1101, 1102, and 1103.

For example, let us assume that four private IP addresses 10.0.0.1 through 10.0.0.4 are allotted to room No. 101 of apartment building No. 1. The first private IP address 10.0.0.1 is recognized as the representative private IP address of room No. 101. When the first incoming and outgoing call terminal 1101 transmits a VoIP call signal, the first gateway 1201 allots the second private IP address 10.0.0.2 to the first incoming and outgoing call terminal 1101. The gatekeeper 13 makes a called number included in the outgoing call of the first incoming and outgoing call terminal 1101 correspond to an incoming external public IP address and carries out call setting, thus enabling the outgoing call.

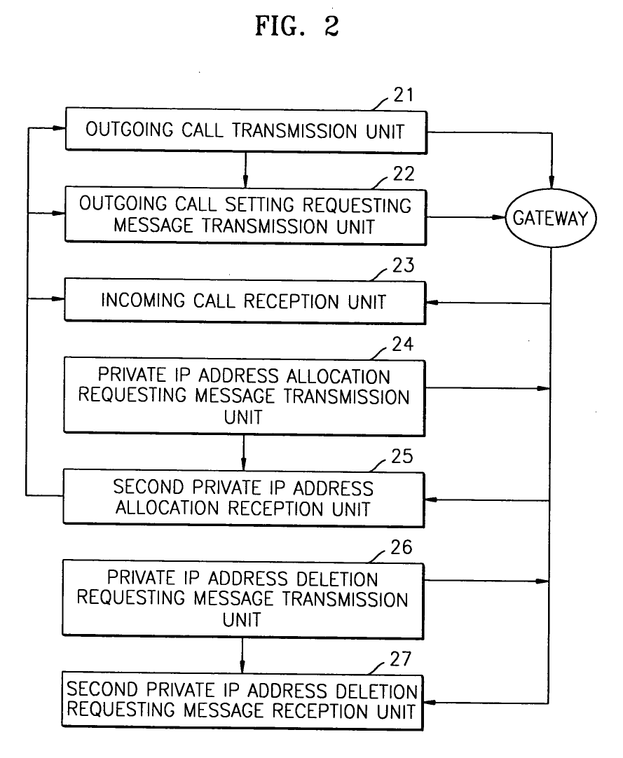

FIG. 2 is a block diagram illustrating an incoming and outgoing call terminal according to an illustrative embodiment of the present invention. The incoming and outgoing call terminal includes an outgoing call transmission unit 21, an outgoing call setting requesting message transmission unit 22, an incoming call reception unit 23, a private IP address allocation requesting message transmission unit 24, a second private IP address allocation reception unit 25, a private IP address deletion requesting message transmission unit 26, and a second private IP address deletion reception unit 27.

The outgoing call transmission unit 21 receives a calling number from a user, i.e., a caller. Thereafter, in a case where a second private IP address, which is the address of an exit of a duplicate private network, is allotted to the incoming and outgoing call terminal, the outgoing call transmission unit 21 generates an outgoing call containing called number information and transmits the outgoing call to a gateway having a first private IP address. The incoming and outgoing call terminal may be an IP phone, a web-pad, or a personal computer (PC). Using the incoming and outgoing call terminal, the caller inputs a phone number at which he or she desires to make a call. For example, using a web-pad, the caller may input a cell phone number of a person whom the caller wants to talk to over the phone, such as 011-1234-5678. Here, the generation and transmission of an outgoing call indicates a process of transmitting a selection signal necessary for access to an exchanger with a speaking circuit closed. The speaking circuit can be closed by lifting a telephone receiver from the hook, and the transmission of the selection signal is enabled by using a rotation-type dial or buttons on the telephone. However, an outgoing call is transmitted to a predetermined incoming call node, belonging to an external network, through the Internet in a packet switching manner. Therefore, only if all nodes along the transmission path are given IP addresses, can the outgoing call be successfully transmitted to the destination node. More specifically, when the incoming and outgoing call terminal is allotted a second private IP address and the gateway is allotted a first private IP address, an outgoing call can be transmitted from the incoming and outgoing call terminal to the gateway.

The outgoing call setting requesting message transmission unit 22 creates a message requesting the setting of an outgoing call and transmits the message to the gateway when the outgoing call is transmitted to the gateway. In order to transmit the outgoing call to the gateway, a path along which the outgoing call is to be transmitted should be set up in advance. Call setting indicates a process of setting communication circuits between incoming and outgoing call terminals, which involves selecting a transmission path over a network according to the address of a source incoming and outgoing call terminal and allowing a connection between the source incoming and outgoing call terminal and a destination incoming and outgoing call terminal. In short, call setting indicates a process of transmitting an address signal from a sending terminal to a receiving terminal over a network. The message requesting the setting of an outgoing call demands that a gatekeeper perform call setting. Therefore, the message requesting the setting of an outgoing call is transmitted from the incoming and outgoing call terminal to the gatekeeper.

In a case where the incoming and outgoing call terminal is allotted a second private IP address and an incoming internal private IP address is also a second private IP address, the incoming call reception unit 23 receives the outgoing call from the gateway. Here, the incoming internal private IP address is translated from an incoming internal public IP address by an NAT server, and the incoming internal public IP address is destination information corresponding to the called number information included in an incoming call and the address of an entrance of the duplicate private network.

Unless the private IP address allocation requesting message transmission unit 24 is allotted a second private IP address, it creates a message requesting private IP address allocation and transmits the message to the gateway having a first private IP address. Here, the message includes information of incoming and outgoing call terminals, directly connected to the gateways, to which private IP addresses are not allotted. Unless the duplicate private network incoming and outgoing call terminal is allotted a second private IP address, the corresponding incoming and outgoing call terminal is not recognizable in the duplicate private network and the Internet. Therefore, it is necessary to issue a request for allotting a second private IP address to the corresponding incoming and outgoing call terminal to the gateway which is in charge of second private IP address allocation. The issued request is the message requesting private IP address allocation and includes the information of the incoming and outgoing call terminals to which private IP addresses are not allotted. When the message is received, the gateway, which is in charge of second private IP address allocation, allots second private IP addresses to the incoming and outgoing call terminals to which private IP addresses are not yet allotted, and this process directly applies to the case of the installation of additional incoming and outgoing call terminals. In response to the message requesting private IP address allocation, the gateway allots a second private IP address to the second private IP address allocation reception unit 25.

When a second private IP address is allotted to the incoming and outgoing call terminal but is no longer in use, the private IP address deletion requesting message transmission unit 26 creates a message requesting the deletion of the second private IP address and transmits the message to the gateway having a first private IP address. When an incoming and outgoing call terminal is withdrawn or no longer in use, the corresponding incoming and outgoing call terminal is deprived of its private IP address for later use of the private IP address by another incoming and outgoing call terminal, and this process makes it possible to prevent shortfalls of private IP addresses and make the utmost use of private IP addresses provided at any moment through more efficient private IP address management. In response to the message requesting the deletion of the second private IP address, the second private IP address deletion reception unit 27 is deprived of the second private IP address by the gateway.

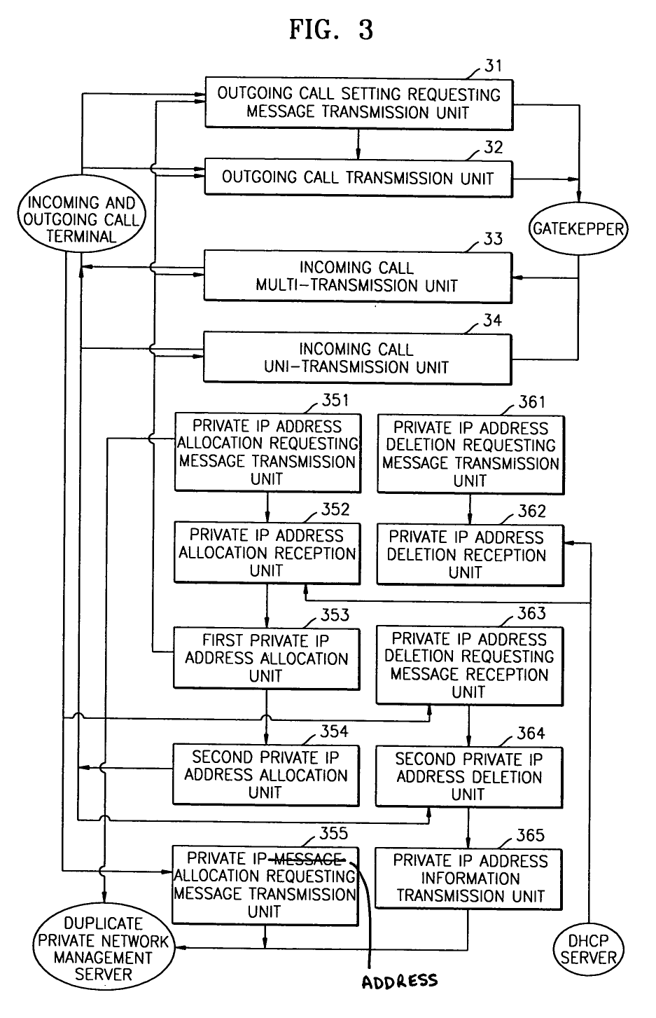

FIG. 3 is a block diagram illustrating a gateway according to an illustrative embodiment of the present invention. The gateway includes an outgoing call setting requesting message transmission unit 31, an outgoing call transmission unit 32, an incoming call multi-transmission unit 33, an incoming call uni-transmission unit 34, a private IP address allocation requesting message transmission unit 351, a private IP address allocation reception unit 352, a first private IP address allocation unit 353, a second private IP address allocation unit 354, a private IP address allocation requesting message transmission unit 355, a private IP address deletion requesting message transmission unit 361, a private IP address deletion reception unit 362, a private IP address deletion requesting message reception unit 363, a second private IP address deletion unit 364, and a private IP address information transmission unit 365.

If a first private IP address, which is a relay address of a duplicate private network, is allotted to the gateway, then the outgoing call setting requesting message transmission unit 31 receives a message requesting the setting of an outgoing call from an incoming and outgoing call terminal to which a second private IP address, which is the address of an exit of the duplicate private network, is allotted, and transmits the message to a gatekeeper to which an outgoing internal public IP address is allotted. The outgoing internal public IP address is translated from a second private IP address by an NAT server and is also source information corresponding to calling number information included in an outgoing call and the address of an entrance of the duplicate private network. As described above, if a first private IP address is allotted to a gateway and a second private IP address is allotted to an incoming and outgoing call terminal connected to the gateway, data packets can be transmitted between the gateway and the incoming and outgoing call terminal. In addition, if a first private IP address is allotted to the gateway and an outgoing call public IP address is allotted to a gatekeeper, data packets can be transmitted between the gateway and the gatekeeper. Therefore, the message requesting the setting of an outgoing call can also be transmitted from the incoming and outgoing call terminal to the gateway. The outgoing call public IP address corresponds to the calling number information included in the outgoing call by the gatekeeper and is a translated version of the second private IP address of the incoming and outgoing call terminal. The outgoing call public IP address is recorded in a source information space in an outgoing call data packet header. Since the outgoing call public IP address can be recognized by an external server, it is also called outgoing call public IP address. When the outgoing call reaches a destination incoming and outgoing call terminal having a destination address recorded in a destination space of the outgoing call data packet header, the calling number can be output to a caller identification (ID) device on the destination incoming and outgoing call terminal with the help of the outgoing call public IP address. For example, supposing that a caller lives in room number 1201 of apartment building No. 101 in apartment area No. 1 and his or her phone number is 100-1101-1201-1, 100-1101-1201-1 is output to the called terminal's caller ID. In the caller's phone number, 100-1101-1201-1, ‘1101’ indicates the serial number of the apartment building where the caller's room is located, ‘1201’ indicates the serial number of the room where the caller lives, and ‘1’ indicates the serial number of the caller's incoming and outgoing call terminal.

When an outgoing call is received from an incoming and outgoing call terminal to which a second private IP address is allotted as a result of the transmission of the message requesting the setting of an outgoing call, the outgoing call transmission unit 32 transmits the outgoing call to a gatekeeper to which an internal public IP address is allotted. As described above, the message requesting the setting of an outgoing call demands that communication circuits, to constitute a transmission path for the outgoing call, should be set. Therefore, if the message requesting the setting of an outgoing call is transmitted to the gatekeeper, an outgoing call, containing voice data and/or image data (for video phone calls), is transmitted to the gatekeeper.

In a case where a first private IP address is allotted to the gateway, the gateway receives an incoming call from the gatekeeper and transmits the incoming call to all incoming and outgoing call terminals connected thereto if the first private IP address is an incoming internal private IP address, which is destination information corresponding to called number information included in the incoming call and is a translated version of an incoming internal public IP address. As described above, a first private IP address is allotted to gateways, and a second private IP address is allotted to incoming and outgoing call terminals. For example, let us assume that a gateway's phone number is 100-1101-1201-0, a first incoming and outgoing call terminal's phone number is 100-1101-1201-1, a second incoming and outgoing call terminal's phone number is 100-1101-1201-2, a third incoming and outgoing call terminal's phone number is 100-1101-1201-3, and private IP addresses 10.0.0.2, 10.0.0.3, and 10.0.0.4 are allotted to the first, second, and third incoming and outgoing call terminals, respectively. Here, 10.0.0.1 is a first private IP address, and 10.0.0.2 through 10.0.0.4 are second private IP addresses. In this case, if a user dials 100-1101-1201-0 at a predetermined node in an external network, a gatekeeper of the external network works together with the gatekeeper of the duplicate private network and associates 100-1101-1201-0 with its corresponding incoming internal public IP address. Then, a gatekeeper having the corresponding incoming internal public IP address receives the incoming call from the external network. Thereafter, an NAT server translates the incoming internal public IP address into the first private IP address 10.0.0.1, and finally, the incoming call arrives at a gateway having an address of 10.0.0.1 through call setting. The gateway that receives the incoming call transmits the incoming call to all incoming and outgoing call terminals connected thereto in a multicasting manner. At this time, if anybody who lives in room No. 1201 picks up the phone, he or she can talk to the caller on the phone. This method is favorable especially when the caller wants to talk to anybody living in room No. 1201 or when a person who is supposed to answer the phone wants to get connected to the caller using any incoming and outgoing call terminal that is closer to his or her current location. 100-1101-1201-0, corresponding to 10.0.0.1, is output from the gatekeeper to the called terminal's caller ID.

If a first private IP address is allotted to the gateway, the incoming call uni-transmission unit 34 receives an incoming call from the gatekeeper. Then, if the first private IP address is not an incoming internal private IP address, the incoming call uni-transmission unit 34 transmits the incoming call to an incoming and outgoing call terminal directly connected thereto and having an incoming internal private IP address. Referring back to the above example, if a user dials 100-1101-1201-1 at the predetermined node in the external network, 100-1101-1201-1 is translated into an incoming internal public IP address by the NAT server, and then the incoming call is transmitted to a gatekeeper having the corresponding incoming internal public IP address from the external network. Thereafter, the NAT server translates the corresponding incoming internal public IP address into a first private IP address 10.0.0.2, and finally, the incoming call arrives at a gateway, which is a relay node of the duplicate private network, through call setting. The gateway that receives the incoming call transmits the incoming call to an incoming and outgoing call terminal having an address of 10.0.0.2 in a unicasting manner. Therefore, 100-1001-1201-1, corresponding to 10.0.0.2, is output to the incoming and outgoing call terminal's caller ID by the gatekeeper. In order for the incoming call to reach the corresponding incoming and outgoing call terminal, which is an exit node of the duplicate private network, the incoming call should pass through the gateway that serves as a relay node. Therefore, if the user dials only part of the phone number, i.e., 100-1101-1201, the resulting incoming call is transmitted to a gateway having an address of 10.0.0.1 through call setting, which is the same result achieved by dialling 100-1101-1201-0.

Unless the private IP address allocation requesting message transmission unit 351 is allotted a first private IP address, it creates a message requesting private IP address allocation and transmits the message to a duplicate private network management server. Here, the message includes information of incoming and outgoing call terminals to which private IP addresses are not allotted. Unless the gateway is allotted a first private IP address, it is necessary to issue a request for private IP address allocation to a DHCP server. The duplicate private network management server serves as a relay server that receives the message requesting private IP address allocation from the gateway and issues private IP address allocation message to the DHCP server. Since incoming and outgoing call terminals may be further installed in or withdrawn from the duplicate private network, gateways inform the duplicate private network management server of changes made in the duplicate private network and enable the DHCP server to efficiently and appropriately allot private IP addresses to the incoming and outgoing call terminals to which private IP addresses are not allotted. The message requesting private IP address allocation contains the information of the incoming and outgoing call terminals to which private IP addresses are not allotted. When the message requesting private IP address allocation is received, the duplicate private network management server generally examines private IP addresses that it currently has and issues an appropriate message, to allot private IP addresses to gateways, to the DHCP server. In response to the reception of the message, the DHCP server appropriately allots private IP addresses to gateways. The gateways, then, allot private IP addresses to the incoming and outgoing call terminals to which private IP addresses are not allotted.

In other words, in response to the reception of the message requesting private IP address allocation, the DHCP server allots private IP addresses to the private IP address allocation reception unit 352 in the first place. Then, the first private IP address allocation unit 353 allots a first private IP address, i.e., a first one of the private IP addresses, allotted from the private IP address allocation reception unit 352, to its corresponding gateway. Thereafter, the first private IP address allocation unit 353 allots the remainder of the private IP addresses to the second private IP address allocation unit 354. The second private IP address allocation unit 354 allots the private IP addresses allotted from the first private IP allocation unit 353, i.e., second private IP addresses, to incoming and outgoing call terminals directly connected thereto. For example, as described above, 10.0.0.1, 10.0.0.2, 10.0.0.3, and 10.0.0.4 can be allotted to a gateway, a first incoming and outgoing call terminal, a second incoming and outgoing call terminal, and a third incoming and outgoing call terminal, respectively, in which case 10.0.0.1 is called the first private IP address and 10.0.0.2 through 10.0.0.4 are called the second private IP addresses.

If the gateway is allotted a first private IP address and receives a message requesting private IP address allocation from an incoming and outgoing call terminal and there is no second private IP address yet to be allotted, the private IP address allocation requesting message transmission unit 355 transmits the message to the duplicate private network management server. In the case of a shortfall of second private IP addresses yet to be allotted to a gateway due to additional installation or withdrawal of incoming and outgoing call terminals, private IP addresses need to be allotted again from the DHCP server to the gateway. In other words, in a case where there is no second private IP address yet to be allotted when the gateway receives the message requesting private IP address allocation from an incoming and outgoing call terminal, the gateway is required to transmit the message to the duplicate private network management server. However, if there are still second private IP addresses yet to be allotted, the gateway allots one of the second private IP addresses yet to be allotted to the incoming and outgoing call terminal which has created the message requesting private IP address allocation.

In a case where a first private IP address is allotted to the gateway but is no longer in use, the private IP address deletion requesting message transmission unit 361 creates a message requesting private IP address deletion and transmits the message to the duplicate private network management server. The message requesting private IP address deletion includes information of private IP addresses that are no longer in use. For example, let us assume that nobody lives in room No. 1201. By keeping private IP addresses, which have already been allotted to gateways but still available because their corresponding gateways are no longer in use, from being available, waste of IP address resources may be caused and restrictions may be put on the dynamic allocation of IP addresses to incoming and outgoing call terminals. Therefore, the gateway creates the message requesting private IP address deletion and transmits the message to the duplicate private network management server. The duplicate private network management server sorts out private IP addresses yet to be allotted in the private IP address database and issues to the DHCP server a message to allocate such yet-to-allotted private IP addresses to other gateways.

In response to the reception of the message requesting private IP address deletion, the private IP address deletion reception unit 362 deletes all private IP addresses allotted from the DHCP server. As described above, if the first private IP address allotted to the gateway is no longer in use, then second private IP addresses allotted to incoming and outgoing call terminals directly connected to the gateway are also no longer in use. Therefore, all the private IP addresses allotted from the DHCP server to the gateway and the incoming and outgoing call terminals connected to the gateway are deleted, and the deleted private IP addresses are classified as private IP addresses yet to be allotted. Then, the duplicate private network management server is informed of the list of private IP addresses yet to be allotted.

If a first private IP address is allotted to the gateway, the private IP address deletion requesting message reception unit 363 receives a message requesting private IP address deletion from an incoming and outgoing call terminal that is withdrawn from the gateway or no longer in use due to mechanical problems. In this case, the first private IP address allotted to the gateway will be continuously used irrespective of the message requesting private IP address deletion. Upon reception of the message requesting private IP address deletion, the second private IP address deletion unit 364 deletes a second private IP address allotted to the corresponding incoming and outgoing call terminal and classifies the deleted second private IP address as a second private IP address yet to be allotted and creates private IP address information, including information of a series of private IP addresses allotted to incoming and outgoing call terminals and information of private IP addresses yet to be allotted, and transmits the private IP address information to the duplicate private network management server. In other words, in response to the reception of the message requesting private IP address deletion, the gateway deletes a second private IP address allotted to the incoming and outgoing call terminal that has transmitted the message requesting private IP address deletion and is no longer in use, classifies the deleted second private IP address as a second private IP address yet to be allotted, and transmits the private IP address information, containing information of the deleted second private IP address, to the duplicate private network management server. Thereafter, the gateway may allot the deleted second private IP address that is now classified as a second private IP address yet to be allotted to a new incoming and outgoing call terminal or allow the duplicate private network management server to allot the deleted second private IP address to an incoming and outgoing call terminal belonging to another gateway.

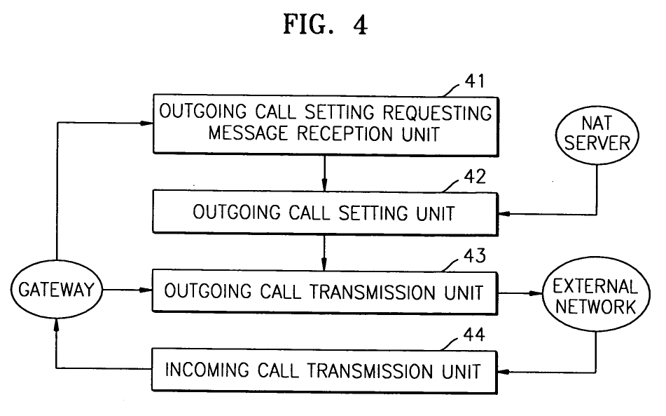

FIG. 4 is a block diagram illustrating a gatekeeper according to an illustrative embodiment of the present invention. Referring to FIG. 4, the gatekeeper includes an outgoing call setting requesting message reception unit 41, an outgoing call setting unit 42, an outgoing call transmission unit 43, and an incoming call transmission unit 44.

The outgoing call setting requesting message reception unit 41 receives a message requesting the setting of an outgoing call from a gateway having a duplicate private network relay node address. As described above, call setting indicates a process of setting communication circuits between incoming and outgoing call terminals, which involves selecting a transmission path over a network according to the address of a source incoming and outgoing call terminal and allowing a connection between the source incoming and outgoing call terminal and a destination incoming and outgoing call terminal. In short, call setting indicates a process of transmitting an address signal from a sending terminal to a receiving terminal over a network. The message requesting the setting of an outgoing call demands that a gatekeeper perform call setting. Therefore, the message requesting the setting of an outgoing call is transmitted from the incoming and outgoing call terminal to the gatekeeper.

Let us assume that the gatekeeper has an incoming external public IP address. Here, the incoming external public IP address is source information corresponding to calling number information included in an outgoing call and also the address of an entrance of a duplicate private network. In addition, the incoming external public IP address is the one that is translated, by an NAT server, from a private IP address of the incoming and outgoing call terminal that has transmitted the message requesting the setting of an outgoing call, in response to the reception of the message requesting the setting of an outgoing call. In this case, the outgoing call setting unit 42 sets a communication path connecting between the gatekeeper and an external incoming node having a predetermined incoming external public IP address corresponding to destination information, i.e., called number information included in the outgoing call. In the header of an outgoing call data packet, spaces are provided for source and destination addresses to be recorded in. Since source information recorded in the source address space is a public IP address of the gatekeeper, it is called the outgoing internal public IP address. Since destination information recorded in the destination address space is a public IP address of a gatekeeper belonging to an external network, it is called the incoming external public IP address. In other words, the communication path set for the outgoing call connects the gatekeeper having an outgoing internal public IP address and the gatekeeper having an incoming external public IP address. At this time, the gatekeeper of the duplicate private network works together with a gatekeeper of the external network to associate the calling number included in the outgoing call with the outgoing internal public IP address and associate the called number with the incoming external public IP address.

The outgoing call transmission unit 43 receives the outgoing call from a predetermined gateway and transmits the outgoing call to the external incoming node along the communication path set for the received outgoing call. At this time, voice data and or image data (for video phone calls) is transmitted to the external incoming node, contained in a ‘payload’ section of the outgoing call data packet. In a case where a recipient's incoming and outgoing call terminal has an incoming external public IP address, such data is directly transmitted to the recipient. On the other hand, in a case where the recipient's incoming and outgoing call terminal has a private IP address that is translated from an incoming external public IP address by an NAT server, such data is transmitted from the gatekeeper of the duplicate private network to the recipient's incoming and outgoing call terminal. In the above two cases, the recipient's incoming and outgoing call terminal may be a PC, an IP phone, or a web-pad.

On the other hand, if the recipient's incoming and outgoing call terminal is a regular telephone, the gatekeeper or gateway of the external incoming node connects public switched telephone network (PSTN) to the Internet, and only the voice or image data contained in the ‘payload’ section of the outgoing call data packet is transmitted to the recipient's telephone. Thereafter, by reproducing the voice or image data in the recipient's telephone, a phone call is realized.

In a case where the gateway has an incoming internal public IP address, the incoming call transmission unit 44 receives an incoming call. Here, the incoming internal public IP address is destination information, i.e., called number information included in an incoming call transmitted along a communication path set by an external outgoing call node of an external server through incoming call setting, and is also the address of an entrance of the duplicate private network. Thereafter, the incoming call transmission unit 44 transmits the received incoming call to a gateway having the address of a relay of the duplicate private network, such as a private IP address that is translated from an incoming internal public IP address by the NAT server. Incoming call setting is carried out by the external outgoing call node, i.e., a gateway of the external network. After the communication path for an incoming call is complete through the incoming call setting, the gatekeeper of the duplicate private network receives the incoming call. Here, the gatekeeper of the duplicate private network is required to have an incoming internal public IP address, which is destination information corresponding to called number information included in the incoming call and is also the address of an entrance of the duplicate private network. The gatekeeper transmits the received incoming call to the gateway having the address of a relay of the duplicate private network, such as a private IP address that is translated from an incoming internal public IP address by the NAT server. For example, let us assume that a gateway's phone number is 100-1101-1201-0, a first incoming and outgoing call terminal's phone number is 100-1101-1201-1, a second incoming and outgoing call terminal's phone number is 100-1101-1201-2, a third incoming and outgoing call terminal's phone number is 100-1101-1201-3, and private IP addresses 10.0.0.1, 10.0.0.2, 10.0.0.3, and 10.0.0.4 are allotted to the gateway, the first, second, and third incoming and outgoing call terminals, respectively. Here, 10.0.0.1 is a first private IP address, and 10.0.0.2 through 10.0.0.4 are second private IP addresses. In this case, if a user dials 100-1101-1201-1 at a predetermined node in the external network, the gatekeeper of the external network works together with the gatekeeper of the duplicate private network and associates 100-1101-1201-1 with its corresponding incoming internal public IP address. Then, a gatekeeper having the corresponding incoming internal public IP address receives the incoming call from the external network. Thereafter, the NAT server translates the incoming internal public IP address into the private IP address 10.0.0.2, and finally, the incoming call arrives at a call terminal having an address of 10.0.0.2 via a gateway having an address of 10.0.0.1 through call setting. In other words, the gatekeeper transmits the incoming call to the gateway having an address of 10.0.0.1 and the call terminal having an address of 10.0.0.2.

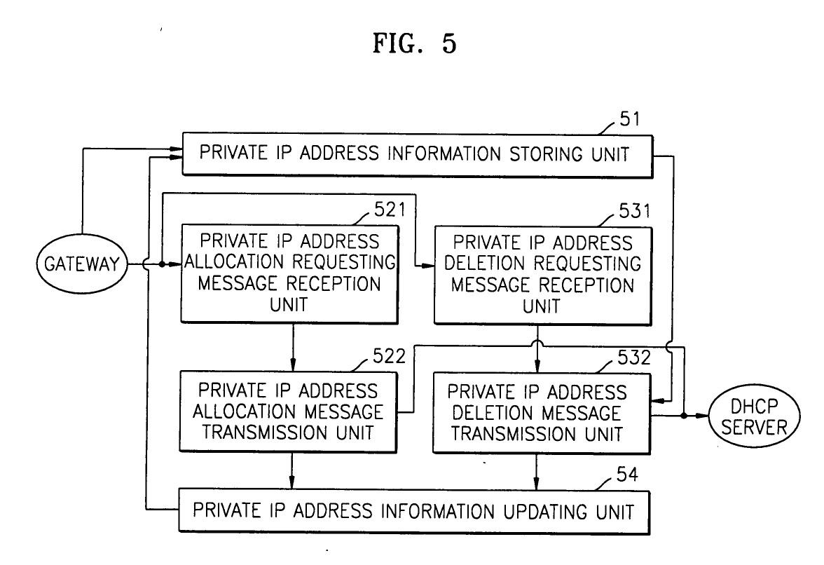

FIG. 5 is a block diagram illustrating a duplicate private network management server according to an illustrative embodiment of the present invention. The duplicate private network management server includes a private IP address information storing unit 51, a private IP address allocation requesting message reception unit 521, a private IP address allocation message transmission unit 522, a private IP address deletion requesting message reception unit 531, a private IP address deletion message transmission unit 532, and a private IP address information updating unit 54.

The private IP address information storing unit 51 creates private IP address information, including a list of private IP addresses allotted to gateways and incoming and outgoing call terminals and a list of private IP addresses yet to be allotted. Alternatively, the private IP address information storing unit 51 receives such private IP address information from a gateway having a duplicate private network relay node and stores the received private IP address information.

The private IP address allocation requesting message reception unit 521 receives the message requesting private IP address allocation, including information of incoming and outgoing call terminals to which private IP addresses are not allotted, from a gateway. In response to the reception of the message requesting private IP address allocation, the private IP address allocation message transmission unit 522 creates the message requesting private IP address allocation based on the private IP address information and transmits the message requesting private IP address allocation to a DHCP server. When the duplicate private network management server receives the message requesting private IP address allocation from the gateway, the private IP address allocation message transmission unit 522 creates the message requesting private IP address allocation, containing a list of private IP addresses yet to be allotted and information of incoming and outgoing call terminals to which private IP addresses are not allotted, and transmits the message to the DHCP server. This process enables the duplicate private network management network to share a private IP address database with the DHCP server.

The private IP address deletion requesting message reception unit 531 receives a message requesting private IP address deletion, including information on private IP addresses that are no longer in use, from a predetermined gateway. In response to the reception of the message requesting private IP address deletion, the private IP address deletion message transmission unit 532 issues a private IP address deletion message, for IP addresses that are no longer in use, to the DHCP server based on the private IP address information. In response to the reception of the message requesting private IP address deletion, the duplicate private network management server issues a message to allot private IP addresses to the DHCP server together with a list of private IP addresses that are currently occupied but are to be classified as private IP addresses yet to be allotted and information of incoming and outgoing call terminals from which private IP addresses need to be deleted. This process enables the duplicate private network management server to share a private IP address database with the DHCP server.

The private IP address information updating unit 54 updates current private IP address information, in response to a message to allot private IP addresses or to delete private IP addresses. More specifically, in response to the message requesting private IP address allocation, the DHCP server may allot a private IP address yet to be allotted to an incoming and outgoing call terminal defined in the private IP address allocation message or to a gateway if a first private IP address is deleted. In response to the message requesting private IP address deletion, the DHCP server deletes a private IP address from an incoming and outgoing call terminal defined in the private IP address deletion message and classifies the deleted private IP address as a private IP address yet to be allotted for later use. Therefore, in order for the DHCP to appropriately allot private IP addresses yet to be allotted to incoming and outgoing call terminals or gateways, any changes made to the list of private IP addresses yet to be allotted should be reflected in the private IP address database.

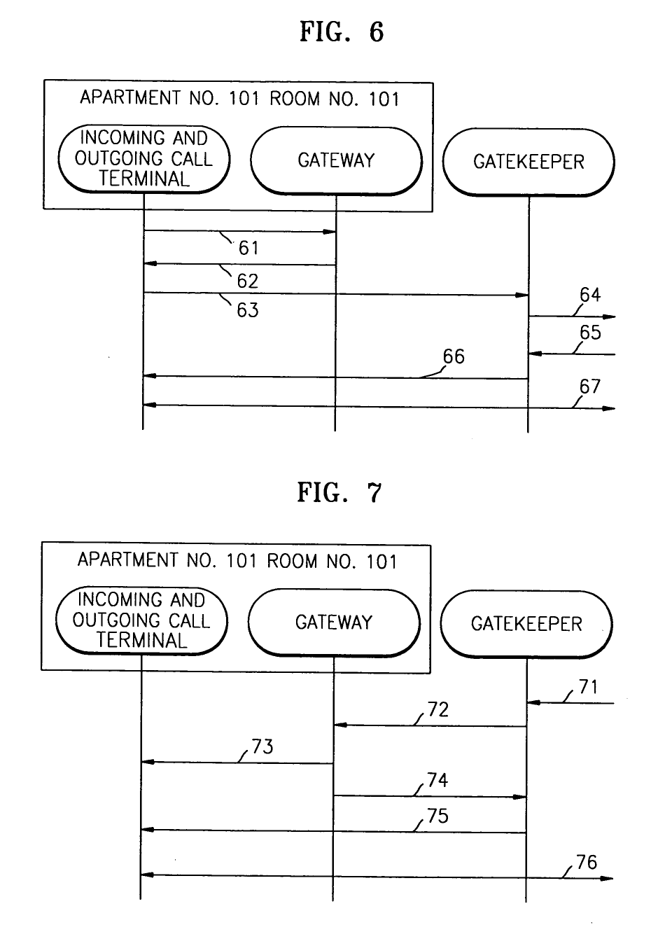

FIG. 6 is a flowchart illustrating a method of creating an outgoing call in an incoming and outgoing call system based on a duplicate private network according to an illustrative embodiment of the present invention.

An incoming and outgoing call terminal receives a calling number from a user. If a second private IP address, which is the address of an exit of a duplicate private network, is allotted to the incoming and outgoing call terminal, the incoming and outgoing call terminal creates an outgoing call, containing information of the received calling number, and transmits the outgoing call to a gateway having a first private IP address (61).

Unless the gateway is not allotted the first private IP address, it creates and transmits a message requesting private IP address allocation, containing information on incoming and outgoing call terminals to which private IP addresses are not allotted. In response to the message requesting private IP address allocation, the gateway is allotted a series of private IP addresses and takes a first one of the allotted private IP addresses as its own IP address. Thereafter, the gateway allots the remaining allotted private IP addresses (i.e., second private IP addresses) to incoming and outgoing call terminals directly connected thereto (62). If the first private IP address allotted to the gateway is no longer in use, the gateway creates and transmits a message requesting private IP address deletion, containing information on private IP addresses that are no longer in use. As a result of the transmission of the message requesting private IP address deletion, the private IP addresses that are no longer in use are deleted.

Thereafter, the incoming and outgoing call terminal creates a message requesting the setting of an outgoing call and transmits the message to the gateway (63). If the first private IP address is allotted to the gateway, the gateway receives the message requesting the setting of an outgoing call from an incoming and outgoing call terminal to which a second private IP address is allotted and transmits the received message requesting the setting of an outgoing call to a gatekeeper to which an outgoing internal public IP address is allotted (63). Here, the outgoing internal public IP address is a translated version of a second private IP address, which is source information corresponding to calling number information included in an outgoing call and is also the address of an entrance of the duplicate private network. If the gateway receives the outgoing call from the incoming and outgoing call terminal to which the second private IP address is allotted, it transmits the outgoing call to a gateway having an internal public IP address 133.

A gatekeeper receives the message requesting the setting of an outgoing call from the gateway (63). If the gatekeeper has an outgoing internal public IP address, it sets a communication path connecting the gateway and an external incoming node having an incoming external public IP address corresponding to destination information, i.e., called number information included in the outgoing call, and receives the outgoing call from the gateway (63). Thereafter, the gatekeeper transmits the outgoing call to the external incoming node along the communication path set for the outgoing call (64). Subsequent processes are carried out according to a general call processing method. In other words, if a recipient's incoming and outgoing call terminal receives the outgoing call, it transmits any response to the outgoing call (65). Then, the gatekeeper transmits the response made by the recipient's incoming and outgoing call terminal to a caller's incoming and outgoing call terminal (66), thus enabling communication between the caller and the called (67).

FIG. 7 is a flowchart illustrating a method of receiving an incoming call in an incoming and outgoing call system based on a duplicate private network according to an illustrative embodiment of the present invention. If a gatekeeper has an incoming internal public IP address, it receives an incoming call (71) and transmits the received incoming call to a gateway having a duplicate private network relay node, such as a private IP address, which is a translated version of the incoming internal public IP address (72). Here, the incoming internal public IP address is destination information, i.e., called number information included in the incoming call that has been transmitted via a communication path set by an external outgoing call node through incoming call setting, and is also the address of an entrance of a duplicate private network.

If a gateway, to which a first private IP address is allotted, receives the incoming call from the gatekeeper (72) and the first private IP address is an incoming internal private IP address, the gateway transmits the received incoming call to all incoming and outgoing call terminals directly connected thereto (73). Unless the first private IP address is the incoming internal private IP address, the gateway transmits the received incoming call to an incoming and outgoing call terminal directly connected thereto and having the incoming internal private IP address (73).

If a second private IP address allotted to an incoming and outgoing call terminal is an incoming internal private IP address, the incoming and outgoing call terminal receives the incoming call from the gateway (73). Here, the incoming internal private IP address is a translated version of an incoming internal public IP address, which is destination information corresponding to called number information included in the incoming call and is also the address of an entrance of the duplicate private network. Subsequent processes are carried out according to a general call processing method. In other words, when the incoming and outgoing call terminal receives the incoming call from the gateway, it transmits a response to the incoming call to the gatekeeper (74), and then the gatekeeper informs the incoming and outgoing call terminal of the reception of the response to the incoming call (75), thus enabling communication between the caller's incoming and outgoing call terminal and the called party's incoming and outgoing call terminal (76).

In order to enable incoming and outgoing calls according to the method of creating an outgoing call and receiving an incoming call based on a duplicate private network, the following processes are required.

Private IP address information needs to be created or received from a gateway and stored. A message requesting private IP address allocation needs to be received from the gateway. Here, the message requesting private IP address allocation is created based on the private IP address information and then transmitted. In addition, a message requesting private IP address deletion needs to be created based on the private IP address information and then transmitted. Then, the private IP address information is updated based on a private IP address allocation message or a private IP address deletion message.

In response to the reception of the message requesting private IP address allocation, private IP addresses are allotted to the gateway first. In response to the reception of the message requesting private IP address deletion, private IP addresses that are no longer in use are deleted from the gateway.

In response to the reception of the message requesting the setting of an outgoing call, a private IP address of an incoming and outgoing call terminal that has transmitted the message is translated into an outgoing internal public IP address. In response to the reception of an incoming call, an incoming internal public IP address is translated into a private IP address.

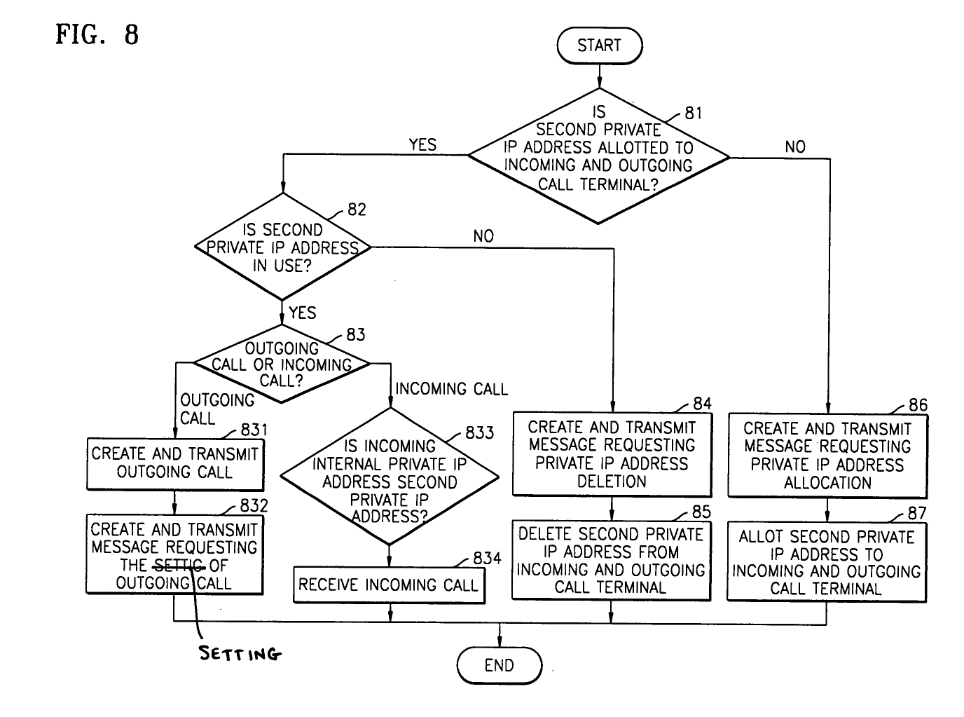

FIG. 8 is a flowchart illustrating a method of creating an outgoing call and receiving an incoming call in an incoming and outgoing call terminal according to an illustrative embodiment of the present invention. If a second private IP address is allotted to an incoming and outgoing call terminal (81 and 82), the incoming and outgoing call terminal receives a calling number, creates an outgoing call (83), containing calling number information, and transmits the outgoing call to a gateway having a first private IP address, which is the address of a relay of the duplicate private network (831). Thereafter, the incoming and outgoing call terminal creates a message requesting the setting of an outgoing call and transmits the message to the gateway (832).

If the second private IP address allotted to the incoming and outgoing call terminal (81 and 82) is an incoming internal private IP address (833), which is destination information, i.e., called number information included in an incoming call (83), and is translated from an incoming internal public IP address by an NAT server, the incoming and outgoing call terminal receives the incoming call from the gateway (834). Here, the incoming internal public IP address is the address of an entrance of a duplicate private network.

If a second private IP address is not allotted to the incoming and outgoing call terminal (81), a message requesting private IP address allocation, including information on incoming and outgoing call terminals, directly connected to the gateway, to which private IP addresses are not allotted, is created and transmitted to the gateway having a first private IP address (86). In response to the reception of the message requesting private IP address allocation, the gateway allots a second private IP address to the incoming and outgoing call terminal (87).

If a second private IP address is allotted to the incoming and outgoing call terminal (81) but no longer in use (82), the incoming and outgoing call terminal creates a message requesting private IP address deletion, including information on a private IP address that is no longer in use, and transmits the message to the gateway having a first private IP address (84). In response to the reception of the message requesting private IP address deletion, the gateway deletes the second private IP address from the incoming and outgoing call terminal (85).

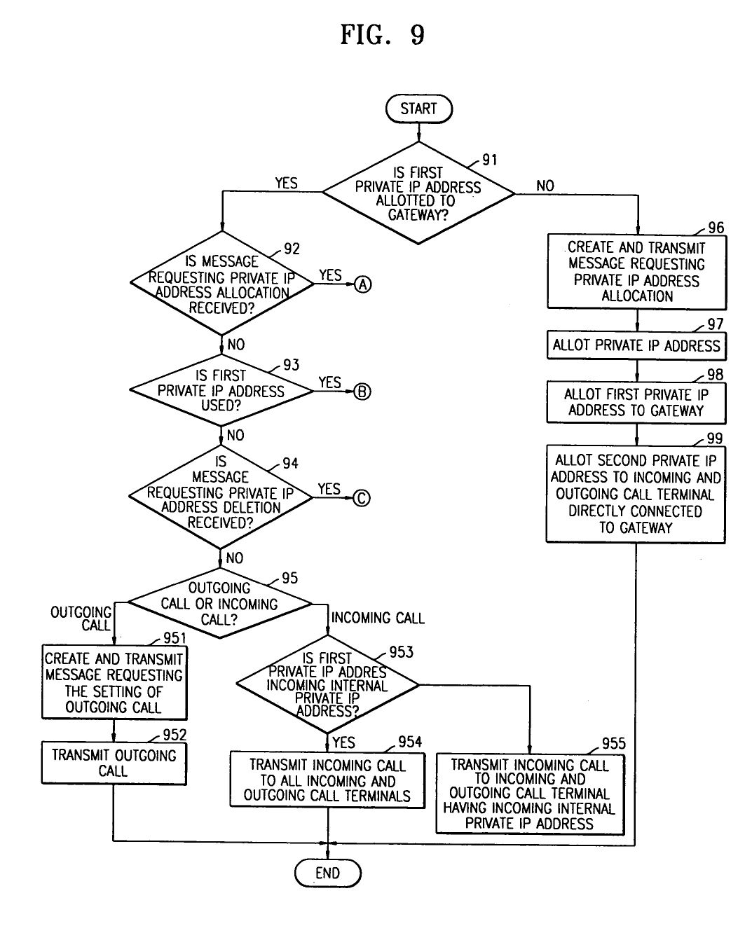

FIG. 9 is a flowchart illustrating a method of creating an outgoing call and receiving an incoming call in a gateway according to an illustrative embodiment of the present invention. If a first private IP address, which is a duplicate private network relay node, is allotted to a gateway (91, 92, 93, and 94), the gateway receives a message requesting the setting of an outgoing call from an incoming and outgoing call terminal having a second private IP address (95) and transmits the received message to a gatekeeper having an outgoing internal public IP address, which is translated from the second private IP address by an NAT server (951). Here, the second private IP address is source information corresponding to calling number information included in the outgoing call and the address of an entrance of a duplicate private network. Thereafter, the outgoing call received from the incoming and outgoing call terminal having a second private IP address is transmitted to the gatekeeper having an outgoing internal public IP address.

If the first private IP address allotted to the gateway is an incoming internal private IP address (953), the gateway transmits an incoming call to all incoming and outgoing call terminals directly connected thereto (954). Here, the incoming internal private IP address is a translated version of an incoming internal public IP address, which is destination information, i.e., called number information included in the incoming call.

Unless the first private IP address allotted to the gateway is the incoming internal private IP address (953), the gateway transmits the incoming call to an incoming and outgoing call terminal having an incoming internal private IP address (955).

Unless a first private IP address is allotted to the gateway (91), the gateway creates a message requesting private IP address allocation, containing information of incoming and outgoing call terminals, to which private IP addresses are not allotted, and transmits the message to a duplicate private network management server (96). Thereafter, in response to the reception of the message requesting private IP address allocation, the DHCP server allots private IP addresses to the gateway (97). Thereafter, the gateway allots one of the private IP addresses given from the DHCP server to itself as its IP address (98). If the private IP address allotted to the gateway is a first private IP address, the gateway allots one of the remaining private IP addresses, i.e., second private IP addresses, to an incoming and outgoing call terminal directly connected thereto (99).

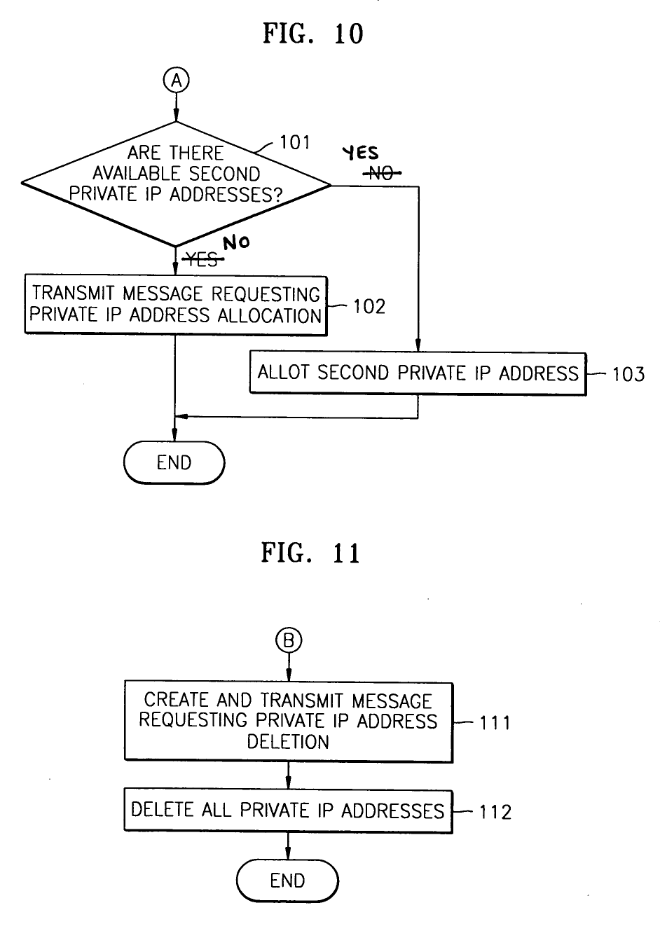

FIG. 10 is a flowchart illustrating the method of FIG. 9 in a case where the message requesting private IP address allocation is received (92). Referring to FIG. 10, the gateway receives the message requesting private IP address allocation from an incoming and outgoing call terminal (92). If the gateway does not have any second private IP addresses yet to be allotted (101), it transmits the message to the duplicate private network management server (102). If the gateway has second private IP addresses yet to be allotted, it allots one of the second private IP addresses yet to be allotted to the incoming and outgoing call terminal that has transmitted the message requesting private IP address allocation (103).

FIG. 11 is a flowchart illustrating the method of FIG. 9 in a case where the first private IP address allotted to the gateway is no longer in use (93). If the first private IP address allotted to the gateway is no longer in use (93), the gateway creates a message requesting private IP address deletion, containing information on private IP addresses that are no longer in use, and transmits the message to the duplicate private network management server (111). Thereafter, all the private IP addresses allotted from the DHCP server that are no longer in use are deleted (112).

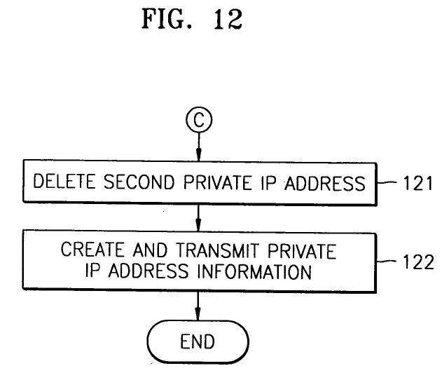

FIG. 12 is a flowchart illustrating the method of FIG. 9 in a case where the message requesting private IP address deletion is received from an incoming and outgoing call terminal (94). If the gateway, to which a first private IP address is allotted, receives the message requesting private IP address deletion from an incoming and outgoing call terminal (94), the gateway deletes a second private IP address from the incoming and outgoing call terminal (121). Thereafter, the gateway classifies the deleted second private IP address as a private IP address yet to be allotted. Thereafter, the gateway creates private IP address information, including information on all private IP addresses yet to be allotted and allotted private IP addresses, and transmits the private IP address information to the duplicate private network management server (122).

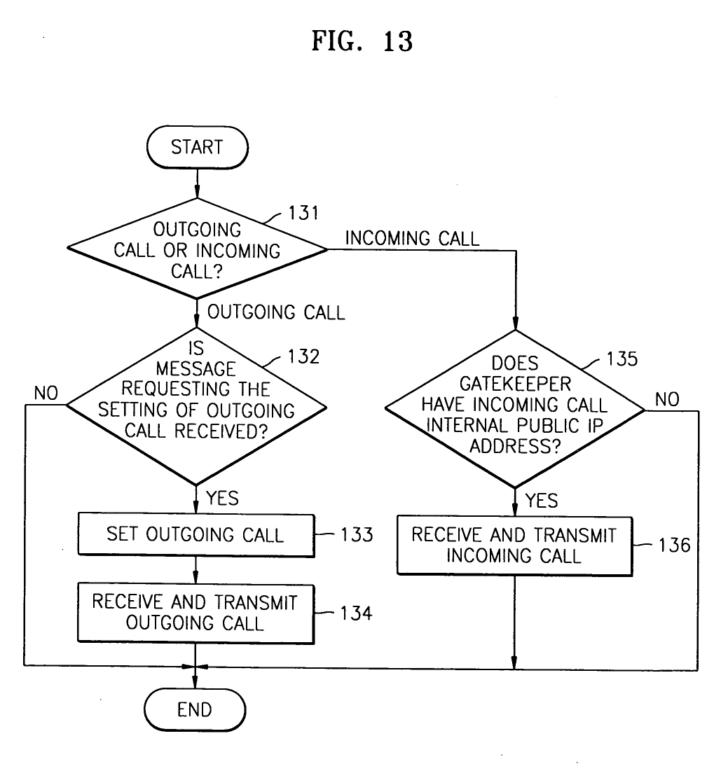

FIG. 13 is a flowchart illustrating a method of creating an outgoing call and receiving an incoming call in a gatekeeper according to an illustrative embodiment of the present invention. A gatekeeper receives a message requesting the setting of an outgoing call from a gateway having the address of a relay of the duplicate private network (131). If the gatekeeper has an outgoing internal public IP address, it sets a communication path connecting a predetermined gateway and an external incoming node having an incoming external public IP address (133). Here, the outgoing internal public IP address allotted to the gatekeeper is translated, by an NAT server, from a private IP address of an incoming and outgoing call terminal that has transmitted the message requesting the setting of an outgoing call and is source information, i.e., calling number information included in an outgoing call, and the address of an entrance of a duplicate private network. The incoming external public IP address is destination information, i.e., called number information included in the outgoing call. Thereafter, the gatekeeper receives the outgoing call from the predetermined gateway and transmits the received outgoing call to the external incoming node along the communication path set for the outgoing call (134).

If the gatekeeper has an incoming internal public IP address (135), it receives an incoming call and transmits the received incoming call to a gateway having the address of a relay of the duplicate private network, such as a private IP address that is translated from a predetermined incoming internal public IP address by the NAT server (136). Here, the incoming internal public IP address is destination information, i.e., called number information included in the incoming call that has been transmitted along a communication path set by an external outgoing call node through incoming call setting (131).

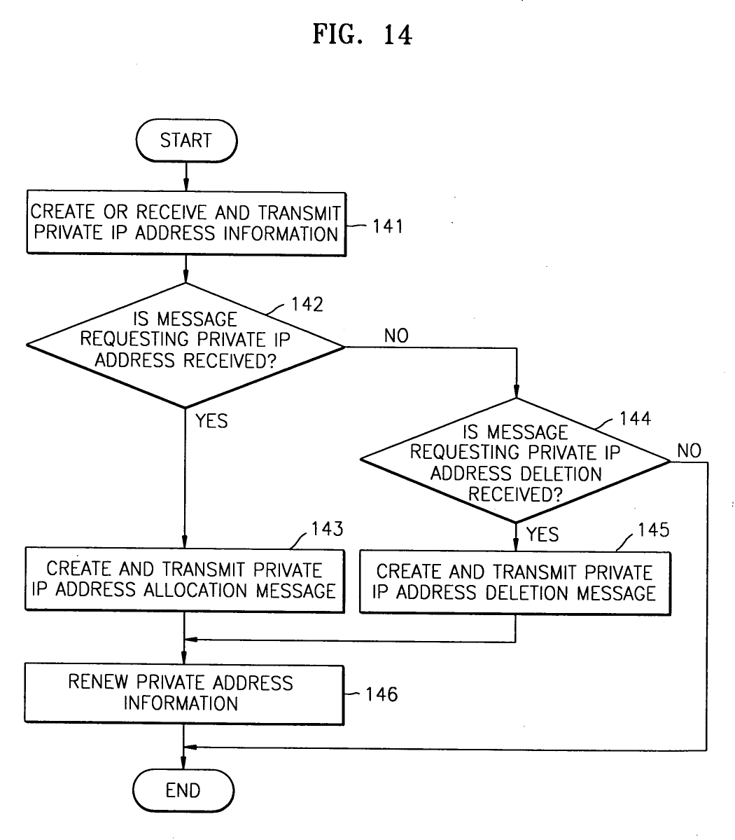

FIG. 14 is a flowchart of a method of creating an outgoing call and receiving an incoming call in a duplicate private network management server according to an illustrative embodiment of the present invention. The duplicate private network management server creates private IP address information, including a private IP address database that covers private IP addresses yet to be allotted as well as allotted private IP addresses (141). Alternatively, the duplicate private network management server receives such private IP address information from a gateway having the address of a relay of the duplicate private network and stores the received private IP address information (141). Thereafter, the duplicate private network management server receives a message requesting private IP address allocation, containing information on incoming and outgoing call terminals, to which private IP addresses are not allotted, from a gateway (142). In response to the reception of the message, the gatekeeper issues a private IP address allocation message to a DHCP server (143). Additionally, the duplicate private network management server can receive a message requesting private IP address deletion (144). In response to the reception of the message, the gatekeeper issues a private IP address deletion message to the DHCP server (145). The gatekeeper updates the current private IP address information based on the deletion or allocation of private IP addresses (146).

The above-described embodiments of the present invention can be written on a computer-readable recording medium as computer programs, and those computer programs can be executed using a regular digital computer.

The computer-readable recording medium includes a magnetic storage medium, such as ROM, a floppy disk, or a hard disk; an optical recording medium, such as CD-ROM or a DVD; and a carrier wave, such as data transmission through the Internet.

According to the present invention, different incoming and outgoing call terminals have different private IP addresses, and data is transmitted on a packet-by-packet basis. Therefore, it is possible for a plurality of users to receive an incoming call or create an outgoing call at the same time. In addition, since private IP addresses allotted to incoming and outgoing call terminals are fixed, the incoming and outgoing call terminals operate as if they were telephones having different phone numbers. Given that in recent years, an increasing number of apartment buildings have been constructed with Internet networks, the present invention becomes more favorable because it can provide cheap communication services based on the Internet.

In addition, in the present invention, private IP addresses can be allotted to incoming and outgoing call terminals dynamically rather than statically. Therefore, it is possible to more flexibly respond to changes in a communication environment caused by further installations or withdrawals of incoming and outgoing call terminals and solve the problem of shortfalls of IP addresses. Moreover, thanks to a multicasting transmission method, it is possible for a user in a house to launch an outgoing call or receive an incoming call using any incoming and outgoing call terminal that is closer to the user's current location in the house.

Furthermore, according to the present invention, it is possible to invent brand-new business models and turn a greater profit based on a new home network solution constituted by incoming and outgoing call terminals, gateways, and a gatekeeper.

The present invention has been particularly shown and described with reference to various illustrative embodiments thereof, and it will be understood by those of ordinary skill in the art that various changes in form and details may be made therein without departing from the spirit and scope of the present invention as defined by the following claims.

1. An incoming and outgoing call terminal on a duplicate private network, comprising:
an outgoing call transmission unit that receives a calling number, creates an outgoing call including information of the received calling number, and transmits the outgoing call to a gateway having a first private internet protocol (IP) address, which is an address of a relay of the duplicate private network, if a second private IP address, which is an address of an exit of the duplicate private network, is allotted to the incoming and outgoing call terminal;
an outgoing call setting requesting message transmission unit that creates a message requesting the setting of an outgoing call and transmits the message to the gateway if the outgoing call transmission unit transmits the outgoing call to the gateway; and
an incoming call reception unit that receives an incoming call from the gateway if the second private IP address allotted to the incoming and outgoing call terminal is an incoming internal private IP address, which is translated from an incoming internal public IP address by a network address translator (NAT) server, wherein the incoming internal public IP address is destination information corresponding to called number information included in the incoming call and the address of an entrance of the duplicate private network.

2. The incoming and outgoing call terminal of claim 1 further comprising:
a private IP address allocation requesting message transmission unit that creates a message requesting private IP address allocation, including information of incoming and outgoing call terminals, directly connected to the gateway, to which private IP addresses are not allotted, and transmits the message to the gateway unless the second private IP address is allotted to the incoming and outgoing call terminal; and
a second private IP address allocation reception unit which is allotted the second private IP address from the gateway in response to the reception of the message requesting private IP address allocation.

3. The incoming and outgoing call terminal of claim 2, wherein the outgoing call and the incoming call are voice-over-IP (VoIP) calls.

4. The incoming and outgoing call terminal of claim 1 further comprising:
a private IP address deletion requesting message transmission unit that creates a message requesting private IP address deletion, including information of a private IP address that is no longer in use, and transmits the message to the gateway if the second private IP address allotted to the incoming and outgoing call terminal is no longer in use; and
a second private IP address deletion reception unit, from which the gateway deletes the second private IP address in response to the reception of the message requesting private IP address deletion.

5. The incoming and outgoing call terminal of claim 4, wherein the outgoing call and the incoming call are voice-over-IP (VoIP) calls.

6. A method of enabling an outgoing call and receiving an incoming call in an incoming and outgoing call terminal on a duplicate private network, comprising:
(a) receiving a calling number, creating an outgoing call including information of the received calling number, and transmitting the outgoing call to a gateway having a first private IP address, which is an address of a relay of the duplicate private network, if a second private IP address, which is an address of an exit of the duplicate private network, is allotted to the incoming and outgoing call terminal;
(b) creating a message requesting the setting of an outgoing call and transmitting the message to the gateway if the outgoing call is transmitted to the gateway; and
(c) receiving an incoming call from the gateway if the second private IP address allotted to the incoming and outgoing call terminal is an incoming internal private IP address, into which an incoming internal public IP address is translated by a network address translator (NAT) server, wherein the incoming internal public IP address is destination information corresponding to called number information included in the incoming call and the address of an entrance of the duplicate private network.

7. The method of claim 6 further comprising:
(d) creating a message requesting private IP address allocation, including information of incoming and outgoing call terminals, directly connected to the gateway, to which private IP addresses are not allotted, and transmitting the message to the gateway unless the second private IP address is allotted to the incoming and outgoing call terminal; and
(e) allotting the second private IP address from the gateway to the incoming and outgoing call terminal in response to the reception of the message requesting private IP address allocation.

8. The method of claim 7, wherein the outgoing call and the incoming call are voice-over-IP (VoIP) calls.

9. The method of claim 6 further comprising:
(d) creating a message requesting private IP address deletion, including information of a private IP address that is no longer in use, and transmitting the message to the gateway if the second private IP address allotted to the incoming and outgoing call terminal is no longer in use; and
(e) the gateway deleting the second private IP address from the incoming and outgoing call terminal in response to the reception of the message requesting private IP address deletion.

10. The method of claim 9, wherein the outgoing call and the incoming call are voice-over-IP (VoIP) calls.

11. A method of enabling an outgoing call and receiving an incoming call in a gateway on a duplicate private network, comprising:
(a) receiving a message requesting setting of an outgoing call from an incoming and outgoing call terminal, to which a second private IP address, which is the address of an exit of the duplicate private network, is allotted, and transmits the message to a gatekeeper having an outgoing internal public IP address, which is translated by a network address translator (NAT) server from the second private IP address and is source information corresponding to calling number information included in an outgoing call and the address of an entrance of the duplicate private network, if a first private IP address, which is the address of a relay of the duplicate private network, is allotted to the gateway;
(b) transmitting the outgoing call to the gatekeeper in response to reception of the outgoing call from the incoming and outgoing call terminal if the outgoing call setting requesting message transmission unit transmits the message requesting the setting of an outgoing call to the gatekeeper;
(c) receiving an incoming call from the gatekeeper and transmitting the received incoming call to all incoming and outgoing call terminals connected to the gateway on the duplicate private network if the first private IP address allotted to the gateway on the duplicate private is an incoming internal private IP address, translated from an incoming internal public IP address, which is destination information corresponding to called number information included in the incoming call; and
(d) receiving an incoming call from the gatekeeper and transmitting the received incoming call to an incoming and outgoing call terminal having the incoming internal private IP address and directly connected to the gateway if the first private IP address allotted to the gateway is not the incoming internal private IP address.

12. The method of claim 11 further comprising:
(e) creating a message requesting private IP address allocation, including information of incoming and outgoing call terminals to which private IP addresses are not allotted, and transmitting the message to a duplicate private network management server unless a first private IP address is allotted to the gateway;
(f) a dynamic host configuration protocol (DHCP) server allotting private IP addresses to the gateway in response to the reception of the message; and
(g) allotting the first private IP address, among the allotted private IP addresses, to the gateway; and
(h) allotting a second private IP address, among the allotted private IP addresses, to the incoming and outgoing call terminal directly connected to the gateway.

13. The method of claim 12 further comprising:
(i) receiving the message requesting private IP address allocation from the incoming and outgoing call terminal and transmitting the message to the duplicate private network management server if the first private IP address is allotted to the gateway, and there are no second private IP addresses yet to be allotted.

14. The method of claim 13, wherein if in step (i), there are second private IP addresses yet to be allotted, one of the second private IP addresses yet to be allotted is allotted to the incoming and outgoing call terminal, directly connected to the gateway, to which a second private IP address is not allotted.

15. The method of claim 14, wherein the outgoing call and the incoming call are voice-over-IP (VoIP) calls.

16. The method of claim 11 further comprising:
(e) creating a message requesting private IP address deletion, including information of a private IP address that is no longer in use, and transmitting the message to a duplicate private network management server if the first private IP address allotted to the gateway is no longer in use; and
(f) deleting all the private IP addresses allotted from a dynamic host configuration protocol (DHCP) server to the gateway.

17. The method of claim 16, wherein the outgoing call and the incoming call are voice-over-IP (VoIP) calls.

18. The method of claim 11 further comprising:
(e) receiving the message requesting private IP address deletion from the incoming and outgoing call terminal if the first private IP address is allotted to the gateway;
(f) deleting a second private IP address from the incoming and outgoing call terminal when the message requesting private IP address deletion is received; and
(g) classifying the deleted second private IP address as a private IP address yet to be allotted, creating private IP address information, including a database of allotted private IP addresses and private IP addresses yet to be allotted, and transmitting the private IP address information to the duplicate private network management server.

19. The method of claim 18, wherein the outgoing call and the incoming call are voice-over-IP (VoIP) calls.

20. A method of enabling an outgoing call and receiving an incoming call in a gatekeeper on a duplicate private network, comprising:
(a) receiving a message requesting the setting of an outgoing call from a gateway having an address of a relay of the duplicate private network;
(b) setting a communication path connecting the gateway and an external incoming node in an external network, having an incoming external public IP address, which is translated by a network address translator (NAT) server from a private IP address of an incoming and outgoing call terminal that has transmitted the message requesting the setting of an outgoing call and is destination information corresponding to called number information included in an outgoing call and an address of an entrance of a duplicate private network, when the outgoing call setting requesting message reception unit receives the message requesting the setting of an outgoing call;
(c) receiving the outgoing call from the gateway and transmitting the received outgoing call to the external incoming node along the communication path for the outgoing call; and
(d) receiving an incoming call and transmitting the received incoming call to a gateway having the address of a relay of the duplicate private network, which is a private IP address translated from the incoming internal public IP address by the NAT server, if the gatekeeper has an incoming internal public IP address, which is destination information corresponding to called number information included in the incoming call that has been transmitted along a communication path by an external outgoing call node through incoming call setting, and is the address of an entrance of a duplicate private network.

21. The method of claim 20, wherein the outgoing call and the incoming call are voice-over-IP (VoIP) calls.

22. The method of claim 20, wherein the external incoming node and the external outgoing call node are arbitrary gatekeepers in the external network.

23. A method of enabling an outgoing call and an incoming call in a duplicate private network management server, comprising:
(a) creating private IP address information, including a database of allotted private IP addresses and private IP addresses yet to be allotted, or receiving the private IP address information from a gateway having an address of a relay of the duplicate private network, and storing the received private IP address information;
(b) receiving a message requesting private IP address allocation, including information on which incoming and outgoing call terminals to which private IP addresses are not allotted, from the gateway;
(c) creating a private IP address allocation message based on the private IP address information in response to the reception of the message requesting private IP address allocation and transmitting the private IP address allocation message to a dynamic host configuration protocol (DHCP) server;
(d) receiving a message requesting private IP address deletion, including information on private IP addresses that are no longer in use, from the gateway;
(e) creating a private IP address deletion message based on the private IP address information, in response to the reception of the message requesting private IP address deletion, and transmitting the private IP address deletion message to the DHCP server; and
(f) updating the private IP address information in response to the private IP address allocation message or the private IP address deletion message.

24. A computer-readable recording medium, on which a program enabling the method of claim 6 is recorded.

25. A computer-readable recording medium, on which a program enabling the method of claim 11 is recorded.

26. A computer-readable recording medium, on which a program enabling the method of claim 20 is recorded.

27. A computer-readable recording medium, on which a program enabling the method of claim 23 is recorded.
